(19) United States
(12) Patent Application Publication
(10) Pub. No.: US 2006/0173795 A1
(43) Pub. Date: Aug. 3, 2006

(54) System for dynamically providing address and indicia information

(76) Inventor: James M. Mattern, Bethany, CT (US)

Correspondence Address: PERMAN & GREEN, 425 POST ROAD, FAIRFIELD, CT, 06824, US

(21) Appl. No.: 11/047,411

(22) Filed: Jan. 31, 2005

(51) Int. Cl. G06F 17/00

(52) U.S. Cl. 705/401

(57) ABSTRACT

A system for dynamically providing labeling information includes a meter with a communications port, and a label operable to receive and display address and indicia information from the meter.

### BACKGROUND OF THE INVENTION

The disclosed embodiments relate to a postal service system that includes a label with communication and display capabilities.

### BRIEF DESCRIPTION OF RELATED DEVELOPMENTS

A high volume postal customer may use a meter which incorporates a Postal Security Device (PSD) to secure the proof of payment of postal indicia. In an exemplary application, indicia may be applied to mailing items that identifies the value of the postage applied and other information. A customer may purchase postage and the purchased value may be stored in the PSD. As the postage indicia is applied to items, the value applied may be deducted from the stored value. Once postage indicia is applied, the item may then be dropped into the collection stream of the particular postal system and subsequently processed for delivery.

In various countries, for example the United States, postal meters may communicate with a remote data center to exchange information related to customer usage and funding for billing purposes and to have postage funds replenished. In the United States, a postal customer generally may add postage to the meter in two ways. The first is to physically take the meter to the postal authority, generally referred to herein as “the post,” where postage is purchased and added to the PSD. The second is to remotely add postage over a network, for example, a telephone line with a modem, or the Internet, where the added postage is deducted from an account usually maintained with a meter vendor or a trusted third party administrator, for example, a financial institution. In this case, customer or postal authority access to a meter's accounting system or memory system generally is not possible. Meters with this type of communication capability may initiate communication with a host computer to add funds or to reestablish authenticity. A communication cycle may be initiated automatically, or by a user of the meter.

Generally a mail piece includes a label that is printed with address information and indicia indicating that postage for the mail piece has been paid. It would be advantageous to provide an intelligent label that is capable of downloading and displaying information that does not require the address and indicia to be determined until it is convenient for the sender.

### SUMMARY OF THE EXEMPLARY EMBODIMENTS

A system for dynamically providing labeling information includes a meter with a communications port, and a label operable to receive and display address and indicia information from the meter.

### BRIEF DESCRIPTION OF THE DRAWINGS

The foregoing aspects and other features of the disclosed embodiments are explained in the following description, taken in connection with the accompanying drawings, wherein:

FIG. 1 shows a block diagram of a system suitable for practicing the disclosed embodiments;

FIG. 2 shows a block diagram of meter according to the disclosed embodiments;

FIG. 3 shows a diagram of a label with display and communication capabilities according to the disclosed embodiments; and

FIG. 4 shows a diagram of a postage infrastructure data center.

### DETAILED DESCRIPTION OF THE PREFERRED EMBODIMENTS

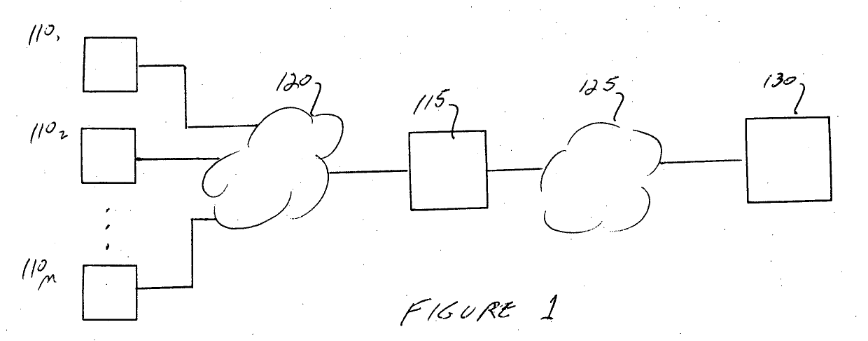

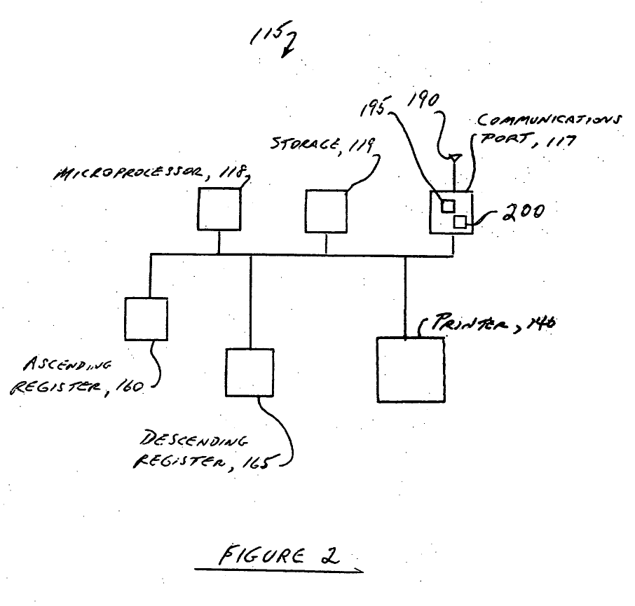

FIG. 1 shows a block diagram of a system 100 suitable for practicing the disclosed embodiments disclosed herein. Although the disclosed embodiments will be described with reference to the embodiment shown in the drawings, it should be understood that the disclosed embodiments can be embodied in many alternate forms of embodiments. In addition, any suitable size, shape or type of elements or materials could be used.

System 100 includes one or more labels 110₁ . . . 110ₙ that communicate with a funding device, shown in FIG. 1 as a meter 115 through a first network 120. System 100 also includes a postal infrastructure data center 130 connected to the meter 115 through a second network 125.

It is a feature of the disclosed embodiments for the one or more labels to 110₁ . . . 110ₙ to communicate with meter 115 to receive address and indicia information. For example, one or more of the labels 110 may be applied to a number of packages. A user may enter or obtain address information through meter 115 for a particular package. The meter 115 may initiate communication with a particular label attached to the package and download information to be displayed on the label, for example, address and indicia information.

As another example, when a particular package with one of the exemplary labels is introduced or about to be introduced into a mail stream, the label may initiate communication with the meter and request address and indicia information to be displayed. Communications between the labels 110₁ . . . 110ₙ and the meter 115 may be wireless.

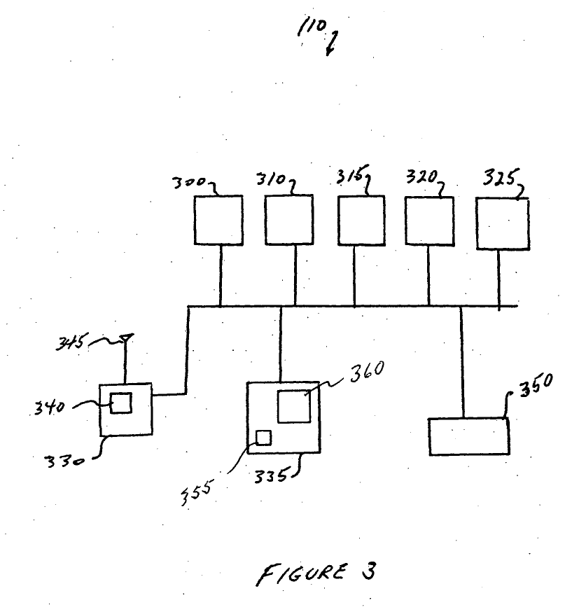

FIG. 2 shows a general block diagram of meter 115. Meter 115 may include a communications port 117 and a microprocessor 118 for performing electronic accounting functions, control functions, and franking functions according to programs stored in a storage device 119. Some of these functions or subsets of these functions may be grouped within a secure perimeter as what is commonly referred to as a Postal Security Device (PSD).

Storage device 119 generally stores machine readable program code which is adapted to cause microprocessor 118 to perform the functions of the disclosed embodiments. Storage device 119 may utilize optical, magnetic, semiconductor, electronic, or other types of suitable devices to store the program code.

Microprocessor 118 typically performs the electronic accounting functions in relation to franking items. Data associated with the accounting functions may include an accumulated total value of credit entered into the PSD, an accumulated total value of charges dispensed by the PSD by franking items, a count of the number of items franked, and a count of the number of items franked with a charge in excess of a predetermined value. The accumulated total value of credit may be stored in an ascending credit register 160, the accumulated total value of postage charges dispensed may be stored in a descending register 165, and the count of items may be stored in an items count register 170. The various registers may be located in storage device 119.

The franking functions performed by microprocessor 118 typically include providing labels 110₁ . . . 110ₙ with address information, indicia information and other information, and reporting the number of items, value marked and other parameters to the accounting functions. Such address information, indicia information and other information are referred to herein as indicia services.

The meter 115 may also provide indicia services locally utilizing a printer 140 and may be capable of franking a label, directly franking a mail piece, or franking any other suitable substrate. Meter 115 may be capable of printing stamps, barcodes, addresses, planet codes, images, text, indicia, logos, graphics, or any other printable item in any desired order.

The control functions performed by microprocessor 118 may include utilizing communications port 117 to communicate with and provide indicia services to the one or more labels 110₁ . . . 110ₙ. Communications port 117 generally includes an antenna 190 and support circuitry 195 or other signaling devices 200 for communicating with the labels 110₁ . . . 110ₙ. The signaling devices 200 may utilize first network 120 to provide an air interface, a wired interface, a wireless interface, or an electrical, electromagnetic, radio, infrared, or other suitable facility for communicating with labels 110₁ . . . 110ₙ. The support circuitry 195 may also include location determining circuitry, for example, a GPS facility for determining the location of the meter 115.

The control functions may further include utilizing communications port 117 for communication with the postal infrastructure data center 130 through the second communication network 125. The antenna 190 and support circuitry 195, as well as the other signaling devices 200 may support such communication in a manner similar to the communication provided with labels 110₁ . . . 110ₙ through first network 120.

The provision of indicia services is performed by microprocessor 118 under the control of programs located in storage device 119.

As another feature of the disclosed embodiments, meter 115 may identify that one or more of the labels 110₁ . . . 110ₙ is capable of communicating with meter 115. For example, meter 115 may attempt to identify any labels 110₁ . . . 110ₙ connected to network 120, for example by polling network addresses or other identification techniques. Meter 115 may also attempt to identify labels by broadcasting a paging signal or other type of signal that requests a response.

First network 120 may include any suitable communications network, for example, the Public Switched Telephone Network (PSTN), a wireless network, a wired network, a Local Area Network (LAN), a Wide Area Network (WAN), virtual private network (VPN), air interface, etc. The air interface may include any suitable wireless communication protocol or signaling techniques or standards, for example TDMA, CDMA, IEEE 802.11, Bluetooth, close range RF, optical, any appropriate satellite communication standards, etc.

After a connection has been established, one or more of the labels 110₁ . . . 110ₙ may utilize meter 115 for indicia services. As mentioned above, the meter 115 generally provides a label with address and indicia information for display by the label 110.

These functions and selections may include purchasing postage, purchasing admission to one or more events, purchasing merchandise or services, or otherwise producing indicia that has value.

As another feature of the disclosed embodiments, meter 115 may have the capability to access the postal infrastructure data center 130 to download updates or additional service capability as desired. For example, meter 115 may access the postal infrastructure data center 130 to provide delivery confirmation for specific mail pieces.

Returning to FIG. 1, as mentioned above, meter 115 communicates the postal infrastructure data center 130 through the second communication network 125. Second communication network 125 may include any suitable communications network, for example, the Public Switched Telephone Network (PSTN), a wireless network, a wired network, a Local Area Network (LAN), a Wide Area Network (WAN), virtual private network (VPN), an air interface, etc. The air interface may include any suitable wireless communication protocols or signaling techniques or standards, for example TDMA, CDMA, IEEE 802.11, Bluetooth, close range RF, optical, any appropriate satellite communication standards, etc. In one embodiment, the first communication network 120 may be the same as the second communication network 125.

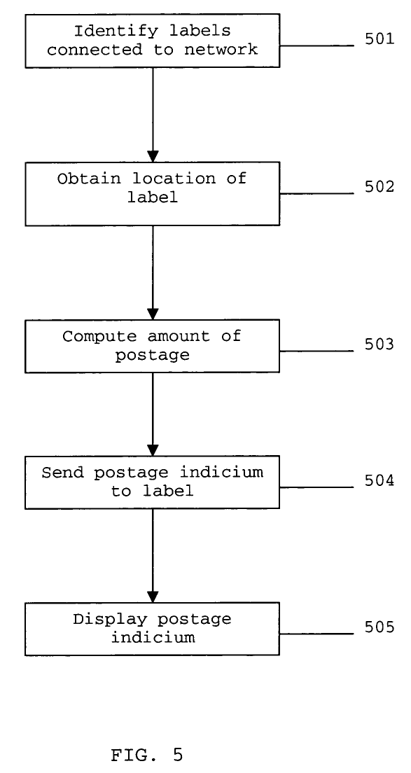

Referring to FIG. 4, the postal infrastructure data center 130 may generally include a server 400, several data bases 410, 415, 420, a power facility 425, for example, a power distribution network, and communication circuitry 430. Communication circuitry 430 may include an antenna 440 and other circuitry and devices 435 for communication with meter 115 through the second network 125.

In other embodiments, devices 435 may include suitable circuitry, programs, transmitters and receivers for any appropriate type of wireless communication utilizing radio frequency (RF), infrared (IR), optical, acoustical, any type of electromagnetic based technology, or any other type of wireless communication. The postal infrastructure data center 130 may also include a user interface facility 445 which may provide local users with access to postal infrastructure data center services.

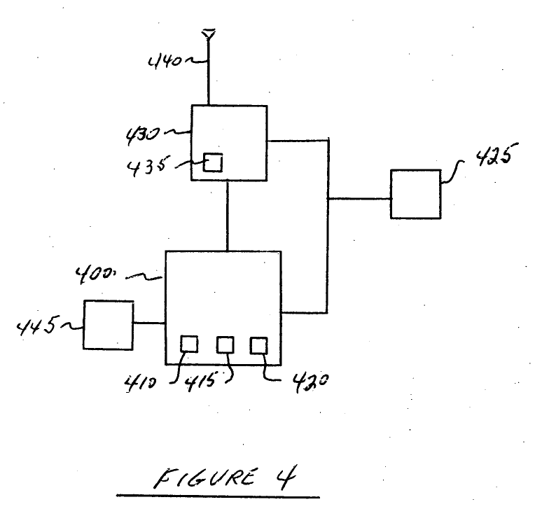

Referring to FIG. 3, the label 110 may generally include a microprocessor 300, on-board memory 310, an analog to digital converter 315, a real time clock interrupt controller 320, a power source 325, for example, a battery, and communication circuitry 330. Communication circuitry 330 may include an antenna 345 and other circuitry and devices 340 for wireless communication with meter 115. In other embodiments, devices 340 may include suitable circuitry, programs, transmitters and receivers for any appropriate type of wireless communication utilizing radio frequency (RF), infrared (IR), optical, acoustical, any type of electromagnetic based technology, or any other type of wireless communication. The devices 340 may also include location determining circuitry, for example a GPS facility, for determining the location of the label 110.

The microprocessor 300 may operate under the control of programs found in the on board memory 310. The on board memory 310 may provide storage information associated with the operation of the label 110. The on board memory 310 may be configured as a non-volatile memory which retains its contents in the event of a power loss.

The portable franking device 110 generally includes a user interface 335 that may include an input device 355, for example a button, keypad, or other input device, and a display 360 which may utilize liquid crystal, plasma, or any other appropriate display technology. The label 110 is generally able to display postage, ticket allowing admission to one or more events, stamps, barcodes, addresses, planet codes, images, text, indicia, logos, graphics, or any other displayable item, either alone or in combination.

As another feature of the disclosed embodiments, meter 115 may download indicia information specific to a location from which a mail piece bearing the label 110 is to be placed into a postal service collection point.

In this aspect of the disclosed embodiments, when communication is established between the label 100 and the meter 115, the meter may interrogate the label as to its location, for example by requesting location information from devices 340. Upon receiving the location information, meter may compute indicia information or postage based on the address that is to be displayed on the label and the present location of the label and download the information to the label to be displayed.

For example, a user in the vicinity of a postal service collection point may operate the user interface to indicate that a mail piece bearing the label 110 is about to be deposited in a mail stream. A connection is established between the label 110 and the meter 115 as described above. The meter determines the location of the label 110 and then may determine which post office or postal system services that location, and may provide appropriate indicia information to the label 110.

It should be understood that the foregoing description is only illustrative of the disclosed embodiments. Various alternatives and modifications can be devised by those skilled in the art without departing from the disclosed embodiments. Accordingly, the disclosed embodiments is intended to embrace all such alternatives, modifications and variances which fall within the scope of the appended claims.

What is claimed is:

1. A system for dynamically providing labeling information comprising:
a meter with a communications port; and
a label operable to receive and display address and indicia information from the meter.

2. The system of claim 1, wherein the communication port is configured for wireless communication.

3. The system of claim 1 further comprising, a postal infrastructure data center in operable communication with the meter.

4. The system of claim 1, wherein the meter is configured to initiate communication with the label and to transmit and receive information to and from the label and a postal infrastructure data center.

5. The system of claim 1, wherein the label is configured initiate communication with the meter and to transmit and receive information to and from the meter.

6. The system of claim 1, wherein the meter is configured to identify the label if the label is connected to a network.

7. The system of claim 1, wherein the label is configured to request indicia services from the meter.

8. The system of claim 1, wherein the label is configured to identify a location of the label.

9. A label for dynamically providing labeling information comprising:
a microprocessor;
communication circuitry connected to the microprocessor and operable to transmit and receive information to and from a postage meter; and
a display connected to the microprocessor operable to display address and indicia information received from the postage meter.

10. The label of claim 9 further comprising, location determining circuitry connected to the microprocessor, the location determining circuitry allowing a location of the label to be transmitted to the postage meter.

11. The label of claim 9 further comprising, a power source operably connected to the components of the label.

12. The label of claim 9, wherein the communication circuitry is configured for wireless communication.

13. The label of claim 9 wherein the label is configured to initiate communication with the postage meter and request information to be displayed.

14. A postage meter for dynamically providing labeling information comprising:
a microprocessor; and
a communications port connected to the microprocessor effecting communication with a label and a data center;
wherein the postage meter is configured to dynamically provide indicia services to the label through the communications port.

15. The meter of claim 14, wherein the meter is further configured to generate postage information and indicia and to cause the postage information and indicia to be printed.

16. The meter of claim 14, wherein the meter is configured to identify the label if the label is connected to a network.

17. The meter of claim 14, wherein the meter is configured to provide delivery confirmation for a mail piece.

18. The meter of claim 14, wherein the meter is configured to initiate communication with the label.

19. A data center comprising:
a server; and
communications circuitry connected to the server for communicating with a postage meter;
wherein the data center is configured to receive delivery confirmation of a mail piece from the postage meter based on location information transmitted by a label.

20. A method for dynamically providing labeling information comprising:
identifying, any labels operable to transmit and receive information connected to a network;
interrogating an identified label to obtain a location of the label;
computing an amount of postage based on the location of the identified label and a destination address associated with the identified label;
sending postage indicium information to the identified label including at least the destination address; and
displaying the postage indicium information on a display of the identified label.

21. The method of claim 20 further comprising, receiving a request for postage indicium from the identified label.

22. The method of claim 20 further comprising, determining which postal authority services the location of the identified label.

23. The method of claim 20, wherein identifying any labels connected to the network includes polling network addresses or broadcasting a paging signal.

24. The method of claim 20, further comprising initiating communication with the identified label from a postage meter.

25. The method of claim 20, wherein the identified label initiates communication with a postage meter.

26. The method of claim 20, further comprising providing delivery confirmation of a mail piece based on a location of the label.

27. The method of claim 20, wherein the identified label identifies the location of the label using location determining circuitry.
